(19) United States
(12) Patent Application Publication
(10) Pub. No.: US 2024/0271715 A1
(43) Pub. Date: Aug. 15, 2024

(54) AIRCRAFT FLUID SYSTEM INCLUDING AN ELECTRIC REGULATION VALVE EQUIPPED WITH AN INTEGRATED ACTUATOR

(71) Applicant: LIEBHERR-AEROSPACE TOULOUSE SAS, Toulouse (FR)

(72) Inventors: Laurent L’EMEILLAT, Toulouse (FR); Eric LAFOND, Toulouse (FR); Raphael VILAMOT, Toulouse (FR)

(73) Assignee: LIEBHERR-AEROSPACE TOULOUSE SAS, Toulouse (FR)

(21) Appl. No.: 18/211,247

(22) Filed: Jun. 17, 2023

(30) Foreign Application Priority Data
Jun. 17, 2022 (FR) 2205953

(51) Int. Cl. F16K 31/04; B64D 13/00; F16K 37/00

(52) U.S. Cl. CPC F16K 31/046; F16K 37/0041; B64D 13/00

(57) ABSTRACT

The invention relates to a fluid system of an aircraft comprising at least one flow conduit for a fluid, at least one electric valve (30, 40, 50) for regulating the flow of fluid in said fluid conduit by movement of a regulating member in said fluid conduit, a central computer (20) configured to be able to issue control instructions to each electric regulating valve (30, 40, 50) depending on the in-flight conditions of said aircraft, and an electric circuit (60) for powering said computer and each electric regulating valve, characterized in that at least one electric regulating valve, referred to as smart valve, is equipped with an integrated actuator connected to the central computer and/or to another smart valve of the fluid system by at least one multiplexed data communications bus (22, 24, 42, 44).

### TECHNICAL FIELD OF THE INVENTION

The invention relates to a fluid system of an aircraft such as an air system, comprising at least one fluid conduit and at least one electric valve for regulating the flow of fluid in this conduit equipped with an integrated actuator.

### TECHNOLOGICAL BACKGROUND

An aircraft comprises different types of fluid system, such as air systems or vapor cycle systems.

An air system generally comprises a plurality of air conduits and a plurality of valves for regulating the air flow in the conduits in order to carry air from the air sources towards air-consuming equipment.

By way of non-limiting example, such an air system is e.g. an air-conditioning system of a cabin of the aircraft. Such an air-conditioning system of an aircraft cabin (also referred to as an “air conditioning pack”) generally comprises a device for drawing in compressed air, more commonly known as bleed air, from at least one compressor of an engine of the aircraft (such as e.g. a propulsion engine or an auxiliary engine of the aircraft), an air-cycle turbomachine, heat exchangers, a network of conduits comprising valves for regulating the air flow, and a central computer configured to be able to control the opening/closing of the regulating valves depending on the in-flight conditions of the aircraft.

The central computer of the air system, known by the acronym IASC, “integrated air system controller”, is also connected to an airplane controller for dialogue therewith and for receiving the information representative of the in-flight conditions of the aircraft.

The electric valves of such an air system generally comprise a closure member such as a butterfly valve mounted on an axis perpendicular to the air flow flowing in the air conduit in which it is disposed. This butterfly valve is mechanically connected to a mechanical reducing gear driven by a brushed electric motor or a stepper motor. The control of this electric motor is transferred to the central computer. In order to do this the IASC computer comprises an electronic control board for each electric valve.

An air system of an aircraft can comprise about ten electric valves, which means that about ten electronic boards must be disposed in the LASC computer.

It is also known that different pieces of equipment controlled by the IASC (electric valves, electropneumatic valves, compressors, probes, fans, etc.) can either have their own power supply (typically a 28V direct current power supply or a 115V alternating current power supply) or be powered by the IASC.

Such a system thus necessitates complex wiring formed from a number of electric wires which extend between the IASC computer and each piece of electric equipment.

Such a system is therefore not easily upgradeable. In fact, the addition of a piece of equipment or the movement of a piece of equipment, such as an electric valve, makes it necessary to modify the wiring, which can lead to an increase in the mass of the system, a change in line impedances, capacitive and inductive coupling between the different cables. Furthermore, the addition of a new valve makes it necessary to integrate a new electronic board into the IASC computer.

The inventors have thus sought to propose a new architecture for a fluid system, such as an air system, which makes it possible to overcome at least some of the above-mentioned disadvantages.

### Aims of the Invention

The invention aims to provide a fluid system, such as an air system, comprising at least one fluid conduit and at least one electric valve for regulating the flow of fluid in this conduit.

The invention also aims to provide, in at least one embodiment, such a system which can be upgradable without necessitating complex rewiring of the whole system.

The invention also aims to provide, in at least one embodiment, such a system which makes possible modifications to the system without modification of the central computer of the system.

The invention also aims to provide, in at least one embodiment, such a system which makes it possible to define local sub-systems, which relieve the load on the central computer of the system.

The invention also aims to provide, in at least one embodiment, such a system which may have no central computer.

### DESCRIPTION OF THE INVENTION

In order to do this, the invention relates to a fluid system (such as an air system or a vapor cycle system) of an aircraft comprising at least one flow conduit for a fluid, at least one piece of electric equipment for regulating the flow of fluid in said fluid conduit by movement of a regulating member in said fluid conduit, a central computer configured to be able to issue control instructions to each piece of electric regulating equipment depending on the in-flight conditions of said aircraft, and an electric circuit for powering said central controller and each piece of electric regulating equipment.

The fluid system in accordance with the invention is characterized in that at least one piece of electric regulating equipment, referred to as smart valve, is equipped with an integrated actuator connected to the central computer and/or to another smart valve of the fluid system by at least one multiplexed data communications bus, referred to as digital bus, said integrated actuator comprising:
an electronic control board equipped with at least one port connected to each digital bus,
an electric motor controlled by said electronic control board and configured to be able to move said regulating member in said fluid conduit,
software loaded on said electronic control board and configured to be able to determine control instructions of the electric motor from data received on at least one input port of said board, referred to as control data.

A system in accordance with the invention can form either an air system (when the fluid is air), or a vapor cycle system (when the fluid is a two-phase fluid). Throughout the following, the system is described in its “air system” version. That being said, a person skilled in the art will easily understand that the teaching applies mutatis mutandis to a vapor cycle system or to any fluid system of an aircraft comprising fluid conduits and valves for regulating the flow of fluid in these conduits.

The electric regulating equipment can be of any type. It may be formed by electric valves, electropneumatic valves, compressors, fans, etc. Throughout the following, electric regulating valves will essentially be mentioned, it being understood that the invention is not limited only to electric regulating valves. A person skilled in the art will easily understand that the teaching applies mutatis mutandis to a system comprising other types of electric regulating equipment such as those mentioned above.

The system in accordance with the invention has in particular the special feature of having transferred the control of the motors of each electric regulating valve directly into each valve, thus forming a smart valve.

Furthermore, each smart valve can be connected to the central computer and/or to another smart valve by at least one digital bus, preferably two unidirectional digital buses. In other words, and in the case of two unidirectional digital buses intended respectively for uplinks (the data are sent by the central computer and/or by another smart valve to this smart valve) and downlinks (the data are sent by this smart valve to the central computer and/or to another smart valve), only two wires are necessary between the computer and/or a smart valve and this smart valve. It is also possible to connect the valves to each other and/or the valves and the computer by two bidirectional digital buses.

A digital bus is preferably a data bus making reference to a controller area network (more commonly known as a CAN bus). This multiplexed bus makes it possible to connect all the electric valves to the central computer via a single cable, thereby limiting the number of specific cables between the central computer and each piece of electric regulating equipment.

A system in accordance with the invention can thus easily be upgraded insofar as it will suffice to connect a new piece of electric regulating equipment to the digital communications bus and to an electric power supply so that it can be brought into use, without necessitating parallel upgrading of the central computer and/or of all of the wiring of the system.

In accordance with the invention, the electronic board receives control data, from which motor control instructions are developed. The control data can come from the central computer and are carried by the downward digital bus.

Advantageously and in accordance with the invention, at least one smart valve is connected to at least one analogue sensor for measurement of a fluid quantity carried by the associated fluid conduit and said electronic board of this smart valve comprises at least one input port connected to this analogue sensor so that the measurements supplied by this analogue sensor can form control data.

According to this variant, a smart valve can receive, as control data, measurements of a quantity of the fluid carried by the conduit, the flow of which it controls. Thus, this assembly formed by a smart valve and one or a plurality of analogue sensors can form a local regulating sub-system, such as a sub-system for regulating pressure, temperature or flow rate, depending on the type of sensor used.

This variant thus makes it possible to relieve the load on the central computer of the fluid system by transferring some of the regulation to the local sub-system thus formed. This thus makes it possible to reduce the overall mass of the fluid system by limiting the wiring and by reducing the requirements of the central computer (some of these functionalities thus being transferred into the local sub-systems thus formed).

Advantageously and in accordance with the invention, the system comprises at least two smart valves connected to each other by a digital bus, said first smart valve, referred to as master valve, being configured to be able to determine and transmit control data to said second smart valve, referred to as slave valve.

According to this advantageous variant, the actuator of the master valve acts as a central computer for the slave valve. In other words and according to this variant, the central computer is not necessary and the master valve can replace the central computer. The smart valves are connected to each other by the digital data buses. Such a system can be used instead of the systems requiring few pieces of regulating equipment, such as helicopter temperature regulating systems.

It should be noted that the slave valves of such a system can also form a local regulating sub-system when they are connected to an analogue sensor for measurement of a fluid quantity as described above.

A fluid system in accordance with the invention can be an air system of an aircraft when the fluid is air. Such an air system is e.g. an air-conditioning system of an aircraft.

A fluid system in accordance with the invention can also be a vapor cycle system when the fluid is a two-phase fluid.

According to other aspects of the invention, the actuator of a smart valve according to the invention can comprise one or a plurality of the following technical features:
the electric motor is a synchronous motor comprising means for indicating its position,
a reducing gear mechanically connects said electric motor and said regulating member,
the software loaded on the electronic board is configured to monitor the smart valve and to manage failure of the actuator,
the loaded software is configurable in order to cause the valve to act as a local regulating sub-system by “pinprog”-type inputs provided on the electronic board.

The invention also relates to a fluid system characterized in combination by all or some of the features mentioned above or below.

### LIST OF FIGURES

Other aims, features and advantages of the invention will become apparent upon reading the following description given solely in a non-limiting way and which makes reference to the attached figures in which:

FIG. 1 is a schematic view of an air system in accordance with a first embodiment of the invention,

FIG. 2 is a schematic view of an air system in accordance with a second embodiment of the invention,

FIG. 3 is a schematic operational view of a smart valve of an air system in accordance with the invention.

### DETAILED DESCRIPTION OF AN EMBODIMENT OF THE INVENTION

In the figures, for the purposes of illustration and clarity, scales and proportions have not been strictly respected. Furthermore, identical, similar or analogous elements are designated by the same reference signs in all the figures.

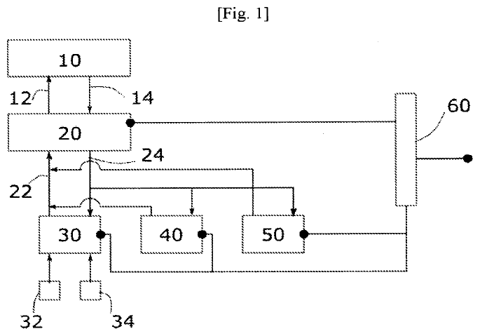

FIG. 1 schematically illustrates an air system of an aircraft comprising a central computer 20 of the air system connected to an airplane controller 10 intended to provide it with information representative of the in-flight conditions. The central computer 20 is e.g. a computer known by the acronym IASC, or integrated air system controller. The central computer 20 can be in dialogue with the airplane controller 10 via the connections 12, 14.

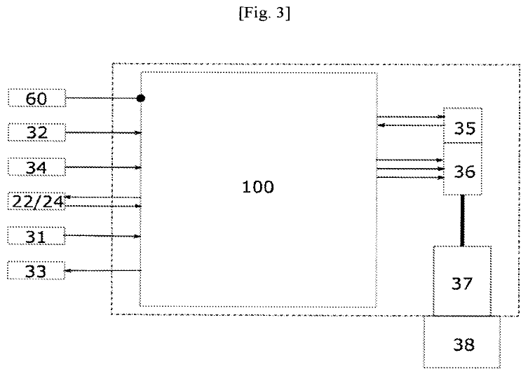

The air system according to the embodiment of FIG. 1 further comprises three valves 30, 40, 50 for regulating the air flow in air conduits, not shown in the figure for reasons of clarity. These regulating valves 30, 40, 50 are smart valves each equipped with an integrated actuator. FIG. 3, described below, schematically illustrates such a smart valve equipped with an integrated actuator. FIG. 1 focusses on the connections between the different pieces of equipment.

The central computer 20 is connected to the valves 30, 40, 50 by two data communications buses 22, 24. The data communications bus 24 is the communications bus, referred to as downward, making it possible to carry control data from the central computer 20 to the regulating valves. The data communications bus 22 is the communications bus, referred to as upward, making it possible to carry data (e.g. the position of the valves or other available information) from the valves 30, 40, 50 to the central computer 20.

The system according to the embodiment of FIG. 1 further comprises analogue sensors 32, 34 connected to the regulating valve 30. These sensors 32, 34 are e.g. sensors for pressure, temperature, etc. of the air flowing in the conduit controlled by this regulating valve 30. The assembly formed by the regulating valve 30 and the sensors 32, 34 thus forms a local regulating sub-system. In other words, the valve 30 can self-regulate depending on the measurements supplied by the sensors 32, 34.

Finally, all the electric equipment of the system in accordance with the invention is powered by an electric circuit 60 which is e.g. a 28-volt airplane circuit.

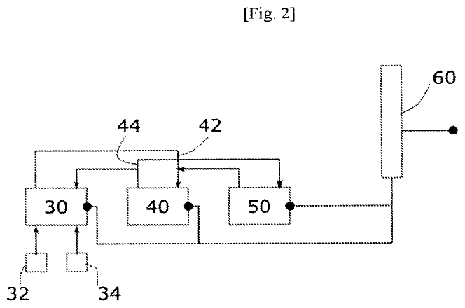

FIG. 2 illustrates another embodiment of an air system in accordance with the invention, in which the central computer 20 is no longer necessary.

Thus, in this embodiment, only the three smart valves 30, 40, 50 are present. Furthermore, the valve 40 is the master valve which acts as the central computer and the valves 30 and 50 are slave valves controlled by the master valve 40. The different valves are connected to each other by digital communications buses 42, 44 which are e.g. CAN buses. The data communications bus 44 is the communications bus, referred to as downward, making it possible to carry control data from the master valve 40 to the slave regulating valves 30, 50. The data communications bus 42 is the communications bus, referred to as upward, making it possible to carry data from the slave valves 30, 50 to the master valve 40.

Furthermore, and in the manner of the embodiment of FIG. 1, the regulating valve 30 is connected to analogue sensors 32, 34 so that the assembly formed by the regulating valve 30 and the sensors 32, 34 constitutes a local regulating sub-system.

FIG. 3 schematically illustrates a smart regulating valve according to one embodiment of the invention, making it possible to form the air systems in accordance with the invention. More specifically, FIG. 3 illustrates the regulating valve 30. That being said, the technical teaching applies mutatis mutandis to the regulating valves 40 and 50.

The special feature of a regulating valve in a system in accordance with the invention is the presence of an integrated actuator comprising a minima an electric motor, an electronic board and loaded software.

In FIG. 3, the actuator of the smart valve comprises an electronic board 100 configured to be supplied with electric power by the electric circuit 60. Furthermore, the board is equipped with ports (illustrated on the left of the electronic board 100) making it possible for the board to receive the data from the analogue sensors 32, 34, to connect the board to the CAN communications bus 22 and 24 (according to the embodiment of FIG. 1), and to configure the board via a “pinprog” type input 31, and to provide discrete information 33 usable by the system.

Furthermore, this board 100 is configured to control the three phases of a motor 36 which is e.g. a synchronous motor associated with a means 35 for indicating the position of the motor. This motor 36 is mechanically connected to a reducing gear 37 which controls the regulating member 38 of the valve 30.

The electronic board 100 is a board controlled by a microprocessor and comprises e.g. a module for filtering the input signals in order to obtain signals in which interference is limited, a control module formed by the microprocessor, memories, and active components for processing the digital and analogue signals received as input by the board, and a power module making it possible to control the electric motor.

The means 35 for indicating the position of the electric motor 36 comprises e.g. three discrete Hall-effect sensors which thus form a position sensor for the electric motor 36. Each Hall effect sensors detects the variations in the magnetic field which causes its state to vary from open to closed and vice versa depending on the position of the rotor of the electric motor 36. The control module of the electronic board 100 counts the number of activations/deactivations of each Hall effect sensor and deduces a speed therefrom.

This indicating of the position of the motor makes possible closed-loop regulation of the speed of the electric motor 36. This indicating also makes it possible, in conjunction with the reduction factor of the reducing gear 37, to determine the position of the regulating member 38 in the conduit within which the regulating valve is disposed.

Furthermore, the electronic board 100 loads software configured to provide the control instructions for the motor 36 (illustrated by the three phases of the motor) depending on the control data received as input by the board. These control data are e.g. the data carried by the downward CAN bus 24 or the data from the analogue sensors 32 and 34.

This software can be of any type and depends on the control logic to which the system in accordance with the invention is targeted.

The software is programmed in particular to analyze and decode the input data from the digital bus, the analogue sensors and the discrete signals. The software is also programmed to analyze the feedback data for the position of the electric motor, to analyze the current data of each phase of the motor and to analyze the voltage data of each phase of the electric motor.

The software is also programmed to monitor different parameters of the electronic board, such as the temperature of the board, the voltage data of the board and the current data of the board.

The software loaded on the electronic board can generally be programmed according to the needs and the indicators for tracking desired within the scope of the target application.

1. A fluid system of an aircraft comprising at least one flow conduit for a fluid, at least one electric valve for regulating the flow of fluid in said fluid conduit by movement of a regulating member in said fluid conduit, a central computer configured to be able to issue control instructions to each electric regulating valve depending on the in-flight conditions of said aircraft, and an electric circuit for powering said computer and each electric regulating valve, characterized in that at least one electric regulating valve, referred to as smart valve, is equipped with an integrated actuator connected to the central computer and/or to another smart valve of the fluid system by at least one multiplexed data communications bus, referred to as digital bus, said integrated actuator comprising:
an electronic control board equipped with at least one input port connected to said digital bus,
an electric motor controlled by said electronic control board and configured to be able to move said regulating member in said fluid conduit,
software loaded on said electronic control board and configured to be able to determine control instructions of the electric motor from data received on at least one input port of said board, referred to as control data.

2. The system as claimed in claim 1, wherein at least one smart valve is connected to at least one analogue sensor for measurement of a fluid quantity carried by the associated fluid conduit. and in that said electronic board of this smart valve comprises at least one input port connected to this analogue sensor so that the measurements supplied by this analogue sensor can form control data.

3. The system as claimed in claim 1, wherein said electric motor of said integrated actuator of at least one smart valve is a synchronous motor comprising means for indicating its position.

4. The system as claimed in claim 1, wherein said integrated actuator of at least one smart valve comprises a reducing gear mechanically connecting said electric motor and said regulating member.

5. The system as claimed in claim 1, wherein the fluid system comprises at least two smart valves connected to each other by the digital bus, said first smart valve, referred to as master valve, being configured to be able to determine and transmit control data to said second smart valve, referred to as slave valve.

6. The system as claimed in claim 1, wherein the fluid system comprises two digital buses connecting the controller to the smart valves, each digital bus being a unidirectional data bus, opposite in direction to the other bus, or a bidirectional bus.

7. The system as claimed in claim 1, wherein said fluid is air so as to form an air system of an aircraft.

8. The system as claimed in claim 1, wherein said fluid is a two-phase fluid so as to form a vapor cycle system.
